(19) United States
(12) Patent Application Publication
(10) Pub. No.: US 2010/0304030 A1
(43) Pub. Date: Dec. 2, 2010

(54) FLAME-RETARDANT FINISHING OF FIBER MATERIALS

(75) Inventors: Salman Dermeik, Augsburg (DE); Walter Nassl, Muhlhausen (DE); Danny Steiner, High Point, NC (US)

Correspondence Address: HUNTSMAN TEXTILE EFFECTS ( GERMANY ) GMBH, LEGAL DEPARTMENT, 10003 WOODLOCH FOREST DRIVE, THE WOODLANDS, TX, 77380, US

(73) Assignee: Huntsman Textile Effects (Germany) GmbH, The Woodlands, TX (US)

(21) Appl. No.: 12/599,712

(22) PCT Filed: May 7, 2008
(86) PCT No.: PCT/EP2008/003644

§ 371 Date: Nov. 11, 2009

(30) Foreign Application Priority Data
May 11, 2007 (EP) 07009463

(51) Int. Cl. B05D 3/10

(52) U.S. Cl. 427/337

(57) ABSTRACT

A process for flame-retardant finishing of fiber materials, for example wovens, is described. A tetrakishydroxymethylphosphonium compound is applied to the fiber material. This is followed by a treatment first with ammonia and then with an oxidizing agent. The fiber material is also treated with an acidic aqueous solution in the course of the process. The fiber materials obtained have good flame-retardant properties and a low formaldehyde content.

This invention relates to a process for flame-retardant finishing of fiber materials.

It is known to endow fiber materials, for example textile fabrics in the form of wovens, with flame-retardant properties by applying certain phosphorus compounds to them.

The phosphorus compounds used for this purpose include for example tetrakishydroxymethylphosphonium compounds of the following structure:

P^{⊕}(CH₂OH)₄X^{⊖},

where X^{⊖} represents an anion, for example a chloride anion,
or their reaction products with organic nitrogen compounds such as urea for example. Such processes for treating fiber materials are described for example in U.S. Pat. No. 2,772,188, U.S. Pat. No. 2,983,623, U.S. Pat. No. 4,068,026, U.S. Pat. No. 4,078,101, U.S. Pat. No. 4,145,463, EP-A 0 294 234, GB-A 2 294 479, U.S. Pat. No. 4,154,878, U.S. Pat. No. 5,480,458, GB-A 938 989, DE-A 26 11 062 and in the article by A. R. Horrocks, “Flame-retardant Finishing of Textiles”, Rev. Prog. Coloration, Vol. 16, 1986, pages 62 to 103.

The prior art processes for flame-retardant finishing of fiber materials with the aforementioned phosphonium compounds or their condensation products have the disadvantage that, after the finishing process has been performed, there are many cases where a high level of formaldehyde is present on the fiber materials or develops in the course of storage and/or further processing of the fiber materials. This level of formaldehyde can amount to several hundred ppm on cellulosic textiles.

It is an object of the present invention to develop a process whereby fiber materials, in particular textile fabrics, can be given an effective flame-retardant finish through the use of tetrakishydroxymethylphosphonium compounds or their condensation products with organic nitrogen compounds without, after the process has been performed, a high level of formaldehyde being present on the fiber materials or developing subsequently.

We have found that this object is achieved by a process for treating fiber materials wherein the following steps a) to e) are carried out in succession:

a) applying to a fiber material an aqueous mixture comprising a tetrakishydroxymethylphosphonium compound and/or a product formed by reaction of a tetrakishydroxymethylphosphonium compound with an organic nitrogen compound as well as water,

b) drying the fiber material obtained after step a),

c) treating the material obtained after step b) with gaseous ammonia and/or ammonia dissolved in a solvent, wherein when ammonia dissolved in a solvent is used the fiber material is preferably dried after step c),

d) optionally treating the material obtained after step c) with an oxidizing agent,

e) washing the fiber material obtained after step d) with an aqueous solution having a pH of at least 7.5, preferably in the range from 7.5 to 12.0, at 20° C.,

wherein furthermore the fiber material is treated with an aqueous solution A whose pH at 20° C. is in the range from 0.5 to 6.5, preferably from 1.5 to 5.5, or whose pH after 5 minutes of heating said solution A to a temperature in the range from 80° C. to 170° C. is in the range mentioned,

wherein the treating of the fiber material with said solution A is carried out either between said steps c) and d) or between said steps d) and e) or, preferably, after step e),

wherein the fiber material is optionally washed with water between step c) and step d) and/or between step d) and step e),

wherein when the treatment of the fiber material with said solution A is carried out after step e) a step e) is preferably carried out again after the treatment with said solution A.

It is advantageous when the fiber material is treated with such an amount of solution A that the fiber material at the end of the process has a formaldehyde content of not more than 150 ppm, preferably of not more than 100 ppm.

The process of the present invention endows textile fabrics composed of fiber material with very effective flame-retardant properties while keeping the post-process formaldehyde content on the fiber material to a low level, i.e., to a value of not more than 150 ppm or even not more than 100 ppm, based on the total weight of the fiber material, when suitable amounts of solution A are used. The flame-retardant properties obtainable with the process of the present invention on fiber materials are highly durable to washing operations. The process of the present invention makes it possible to ensure that the level of phosphorus present on the fabric after application of the phosphonium compound, i.e., after performance of step a), decreases only relatively little, if at all, in the course of the subsequent process steps. This holds particularly when the application of the aqueous solution A is carried out later than process step e). It is of advantage when, after the flame-retardant finishing of textile fabrics has been performed, the phosphorus content on the fabric is only slightly lower than the value obtained directly after the application of the phosphorus compound and subsequent drying. The reason is that a higher phosphorus content leads to a more effective flame-retardant effect.

The process of the present invention provides a pleasantly soft hand to the fiber materials as well as effective flame-retardant properties.

Process steps a) to e) are preferably carried out continuously in succession.

The fiber materials treated by the process of the present invention are preferably textile fabrics, in particular in the form of wovens or nonwovens. They can consist of synthetic fibers such as polyester or polyamide or of natural fibers such as cotton. Blends of various fibers are also contemplated. Preferably, the fiber materials consist of cellulose fibers such as for example cotton or regenerated cellulose to an extent in the range from 50% to 100% by weight. The remaining 0% to 50% by weight can be synthetic fibers, for example polyester fibers or polyamide fibers.

It is a particular advantage of the process according to the present invention that the process makes it possible that, after the treatment of the fiber materials, a low formaldehyde content on the fiber materials is achieved, namely a content of 150 ppm or less, based on the total weight of the fiber material.

The values specified here and hereinbelow and also in the claims for the level or content of formaldehyde on the fiber materials relate to a method of determination in line with EN ISO 14184-1 (corresponding to Japan Law 112-1984), First Edition 1998-12-15. The method specified in this EN standard was somewhat modified for determining the formaldehyde values in the context of the present invention. The modification took the form of omitting any conditioning of the samples.

That the fiber materials contain formaldehyde at all may be because the methyloiphosphonium compounds used contain free formaldehyde or release formaldehyde during the treatment of the fibers with NH₃ or thermal treatments.

The first step (step a) of the process according to the present invention consists in applying an aqueous mixture to the fiber material, preferably to a textile fabric in the form of a woven or nonwoven. The aqueous mixture can be applied to the fiber material by methods that are common general knowledge in textile finishing. An operation involving a pad-mangle is very useful. The padding liquor may contain the hereinbelow more particularly described tetrakishydroxymethylphosphonium compound in a concentration as customary for flame-retardant finishing. The concentration is determined in the individual case by factors including the level of the flame-retardant effect desired.

The aqueous mixture applied to the fiber material in step a), as well as water, contains a tetrakishydroxymethylphosphonium compound, hereinafter referred to as THP, or a product formed by reaction of THP with an organic nitrogen compound. The aqueous mixture may also contain both kinds of these products, i.e., a mixture of THP and the aforementioned THP reaction product. The aqueous mixture may further comprise further products known for textile finishing. Examples thereof are oil- and/or water-repellent agents such as fluorine-containing polymers and/or polysiloxanes, or known softeners, or known cellulose crosslinkers as used for crease resist finishing of cellulose materials.

As THP there may be used compounds of the following structure:

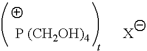

or else mixtures of such compounds, where X^{⊖} is an anion and t is the valency of this anion. Useful anions X include for example sulfate, hydrogensulfate, phosphate, monohydrogenphosphate, dihydrogenphosphate and acetate.

The chloride anion is particularly useful as anion X^{⊖}.

In place of a THP compound or a mixture of THP compounds the aqueous mixture used in process step a) may also contain a product formed by reaction of THP with an organic nitrogen compound. A mixture of THP and such a THP reaction product can also be used. Useful THP reaction products include for example those formed by reaction of THP with melamine, dicyandiamide, urea or thiourea, or by reaction of THP with a mixture comprising two or more products of the kind mentioned.

A product very particularly suitable for use in the aqueous mixture used in step a) is formed by condensation reaction of THP with urea, the THP used preferably being tetrakishydroxymethylphosphonium chloride

P^{⊕}(CH₂OH)₄Cl^{⊖}.

Very good results are obtained on using a product formed by reaction of 2 mol of the tetrakishydroxymethylphosphonium compound with 0.7 to 1.5 mol of urea, this reaction being carried out in the temperature range from 20° C. to 120° C.

THP compounds, in particular the chloride, are commercially available and are obtainable by generally commonly known processes.

A product useful for the process of the present invention is available from Huntsman Textile Effects (Germany) GmbH under the name of PYROVATEX® ACS. This comprises a reaction product of THP with urea.

Useful reaction products of THP and nitrogen compounds and methods of making them are further described in U.S. Pat. No. 2,809,941, GB-A 938 989, U.S. Pat. No. 4,154,878 (see therein for example column 4 lines 6 to 20), DE-A 26 11 062 and in U.S. Pat. No. 2,983,623. The products mentioned in these references, formed by reaction/condensation of THP with organic nitrogen compounds, are also suitable for use in step a) of the process according to the present invention.

The process of the present invention gives good results on using in process step a) a reaction product of 2 mol of THP and 0.7 to 1.5 mol of urea, as described above, and when the aqueous mixture used in step a) comprises 10% to 50% by weight of this reaction product.

Step a) of the process according to the present invention is followed by process step b) wherein the fiber material is dried. This drying is preferably effected under such conditions that, after step b) has been performed, the fiber material has a water content of at least 3% by weight. The upper limit for the water content after drying is preferably 25% by weight. The water content value is based on the total weight of the fiber material after performance of step b).

Process step b) is followed by step c). It consists in treating the fiber material with ammonia. The ammonia is used as a gas or as a solution in a solvent. Water is a very useful solvent. It is also possible to treat the fiber material with both gaseous and dissolved ammonia, in which case these two treatment steps can be carried out in succession. When the fiber material is treated with an aqueous ammonia solution in step c), it is preferably dried subsequently, advantageously such that it has a water content of 5% to 25% by weight, based on the total weight of the fiber material, after drying.

Step c) can be carried out under conditions known from the prior art, for example from U.S. Pat. No. 2,983,623 and U.S. Pat. No. 2,772,188.

The next step (=step d)) of the process according to the present invention is not absolutely necessary, but is preferably carried out and consists in treating the fiber material with an oxidizing agent. Useful oxidizing agents include metal peroxides, perborates, air and oxygen. It is particularly preferable to perform step d) of the process according to the present invention using an aqueous solution of hydrogen peroxide. This solution advantageously comprises 0.1% to 20% by weight of H₂O₂, and the fiber material is preferably dipped into this solution for a period between 20 and 90 seconds.

Suitable processing conditions for this oxidizing step are apparent from Example 1 of U.S. Pat. No. 2,983,623, also from column 3 lines 20 to 27 of U.S. Pat. No. 4,078,101, from Example 5 of U.S. Pat. No. 4,145,463 and Example 1 of GB 938 989.

It is advantageous to perform a step d) because it enhances the durability of the flame-retardant effects and reduces the level of free formaldehyde on the fiber material after completion of the process to lower values.

The fiber material obtained after step d) of the process according to the present invention is washed in the next step, process step e). This washing is done with an aqueous solution having a pH of at least 7.5, preferably in the range from 7.5 to 12.0, at 20° C. Inorganic salts, for example sodium carbonate, can be used for setting the pH. The wash can be carried out for example by dipping the fiber material into the aqueous solution for a period of 1 to 90 minutes and preferably providing for mechanical agitation of the aqueous solution during the dipping phase.

However, apart from in step e) additionally further washes can be carried out in the course of the process of the present invention, for example between step c) and step d) and/or between step d) and step e).

It is of essential importance for the process of the present invention that the fiber material be treated with an aqueous solution A. This process step absolutely has to be carried out. It can be carried out either between process steps c) and d) or between steps d) and e) or after step e). It is preferable to perform the treatment with the aqueous solution A after process step e). This is because we found that in this case the phosphorus content of the fiber material (expressed in % by weight of P) is higher after completion of the process according to the present invention than when the treatment with the aqueous solution A is carried out earlier than process step e) while the procedure otherwise remains the same. A higher phosphorus content on the fiber material leads to enhanced flame-retardant properties.

The treatment of the fiber material with a suitable amount of solution A, for example by dipping the fiber material into the solution A, advantageously with simultaneous mechanical agitation, makes it possible to ensure that the formaldehyde content on the fiber material after completion of the process according to the present invention is not higher than 150 ppm or even not higher than 100 ppm based on the weight of the fiber material. This is on the basis of the abovementioned method of determination in accordance with the standard EN ISO 14184-1.

By contrast, fiber materials where the treatment with a solution A is not carried out frequently have formaldehyde content values of several hundred ppm.

In order that the treatment with the aqueous solution A can achieve formaldehyde content values of 150 ppm or less, the following conditions have to be complied with:
The pH of solution A either has to be in the range from 0.5 to 6.5 at 20° C. or has to assume a value in the range mentioned after solution A has been heated for 5 minutes to a temperature in the range from 110° C. to 170° C. It is particularly favorable for solution A to have a pH at 20° C. in the range from 1.5 to 5.5 from the start or after heating.
When using a solution A whose pH only falls into the stated range after heating, the fiber material treated with solution A has to be appropriately heated in order that a pH, measured at 20° C., in the stated range is obtained.
When the treatment of the fiber material is only carried out after the abovementioned process step e), it is necessary that following the treatment with solution A the fiber material again be subjected to a step e) as described above. This is because if no process step e) is carried out after treatment with the aqueous solution A, formaldehyde content values of 150 ppm or less cannot be safely achieved, if at all.
The treatment with the aqueous solution A is preferably done with such amounts of solution A and during such a period that, after the process of the present invention has ended, the fiber material has a formaldehyde content of not more than 150 ppm or preferably of not more than 100 ppm, based on the weight of the fiber material. The requisite amounts of solution A and requisite periods depend on the identity and amount of the fiber material and its pretreatment, and can be determined in the individual case by means of a few tests.

The aqueous solution A has a pH at 20° C. in the acidic range, namely in the range from 0.5 to 6.5, preferably from 1.5 to 5.5, either from the beginning or after the heating described. This is due to ingredients in solution A.

Phosphoric acid is a very useful ingredient for solution A. Sulfuric acid can also be used, for example. Useful ingredients for aqueous solution A also include monoammonium phosphate or a mixture of dicyandiamide and phosphoric acid. It will be appreciated that it is also possible for a plurality of the compounds mentioned to be present in solution A.

The treatment of the fiber material with solution A can be for example such that, directly after process step e), the fiber material is rinsed with water and hydroextracted and that it is subsequently treated with an acidic bath comprising solution A, followed in turn by a step e) and a drying operation, for example at 110° C.

Another very useful process variant consists in the fiber material after step e) first being dried and then being treated with solution A by padding.

It is then advisable to store the material at room temperature for about 20-25 hours or to heat it briefly to a temperature of 140° C.-170° C. This is preferably again followed by a step e).

In a particularly preferred embodiment of the process according to the present invention, aqueous solution A comprises a product that binds formaldehyde. This permits a further lowering of the formaldehyde content on the fiber material present after completion of the process according to the present invention. Nitrogen compounds such as amines or acid amides are useful as products capable of chemically binding formaldehyde. These nitrogen compounds are converted by reaction with formaldehyde into the corresponding N-methylol compounds. Dicyandiamide (cyanoguanidine) is one example of a useful product:

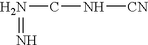

Urea is particularly useful as a formaldehyde-binding product. A preferred embodiment of the process according to the present invention is therefore characterized in that the aqueous solution A comprises urea.

The examples which follow illustrate the invention.

### EXAMPLE 1

### Non-Inventive, Comparative Example

This example is not inventive because, although steps a) to e) of the process according to the present invention were carried out, there was no treatment with an (acidic) solution A.

A woven 100% cotton fabric (dyed blue) was treated in step a) with an aqueous solution of a THPC adduct. The THPC adduct was an adduct of tetrakishydroxymethylphosphonium chloride and urea, used as an approximately 75% by weight solution in water. The fabric was treated by padding with 500 g of the aforementioned adduct per liter of liquor. The padding liquor further comprised 4 g/l of triethanolamine and 5 g/l of a wetting agent.

The wet pickup of padding liquor was about 78% by weight, based on untreated fabric. After padding, the fabric was dried at 80° C. for about 1 minute (step b)), then treated for 1 minute with gaseous ammonia (step c)) and then for 1 minute with air, then the fabric was treated for 2 minutes in an aqueous bath comprising per liter 20 g of a 35% aqueous hydrogen peroxide solution (step d)). The fabric was washed with water and then treated with a sodium carbonate solution at 60° C. for 20 minutes (step e)). The sodium carbonate solution comprised 10 g of Na₂CO₃/1. Subsequently, the fabric was washed and hydroextracted.

### EXAMPLES 2 A TO 2 D

### Inventive Examples

Example 1 was repeated except that the treatment with sodium carbonate was followed by treatment with an acidic solution (solution A) and subsequently once more by a treatment with the same Na₂CO₃ solution and under the same conditions as mentioned in Example 1.

The following procedure was adopted:

After the first treatment with Na₂CO₃ as described in Example 1, the fabric was washed and hydroextracted as in Example 1. This was followed by a treatment with an acidic solution A, specifically

1 minute at 80° C. in Example 2 a,

3 minutes at 80° C. in Example 2 b,

2 minutes at 60° C. in Example 2 c,

5 minutes at 60° C. in Example 2 d.

The acidic solution A consisted in all Examples 2 a to 2 d of about 400 g of tap water, about 165 g of 80% phosphoric acid and about 320 g of urea.

After the treatment with solution A, the samples of Examples 2 a to 2 d were once more washed with Na₂CO₃ solution (10 μl) at 60° C. for 10 minutes and dried at 110° C. for 10 minutes.

The fabric samples obtained in Examples 1 and 2 a to 2 d were subjected to a determination of the formaldehyde content in accordance with the above-mentioned method. Table 1 shows the results.

TABLE 1

| Fabric sample | Formaldehyde content |
|---|---|
| of example | ppm (based on fabric) |
| 1 | 470 |
| 2 a | 35 |
| 2 b | 30 |
| 2 c | 75 |
| 2 d | 45 |

It is clearly apparent that the treatment with solution A (Examples 2 a to 2 d) brings about a significant improvement.

In another series of tests, the fabric samples were dried after performance of steps a) to e) in accordance with Example 1, and padded with solutions A as described in Example 2. After padding, some of the samples were stored at room temperature for 20 hours, while others were heated to 160° C. for a few minutes. This was followed by another performance of step e) (washing with sodium carbonate solution, as described in Example 2) and subsequently by a drying operation (10 minutes/110° C.).

Determination of the formaldehyde content gave values of about 40 ppm for the samples stored for 20 hours and of about 45 ppm for the samples heated to 160° C.

1. A process for treating fiber materials comprising:
a) applying to a fiber material an aqueous mixture comprising a tetrakishydroxymethyl-phosphonium compound and/or a product formed by reaction of a tetrakishydroxymethyl-phosphonium compound with an organic nitrogen compound as well as water,
b) drying the fiber material obtained after step a),
c) treating the material obtained after step b) with gaseous ammonia and/or ammonia dissolved in a solvent, wherein when ammonia dissolved in a solvent is used the fiber material is optionally dried after step c),
d) optionally treating the material obtained after step c) with an oxidizing agent,
e) washing the fiber material obtained after step d) with an aqueous solution having a pH of at least 7.5 at 20° C.,
wherein furthermore the fiber material is treated with an aqueous solution A whose pH at 20° C. is in the range from 0.5 to 6.5 or whose pH after 5 minutes of heating said solution A to a temperature in the range from 80° C. to 170° C. is in the range mentioned,
wherein the treating of the fiber material with said solution A is carried out either between said steps c) and d) or between said steps d) and e) or after step e), wherein the fiber material is optionally washed with water between step c) and step d) and/or between step d) and step e),
and wherein when the treatment of the fiber material with said solution A is carried out after step e) a step e) is carried out again after the treatment with said solution A.

2. The process according to claim 1, characterized in that the fiber material is treated with such an amount of solution A that the fiber material at the end of the process has a formaldehyde content of not more than 150 ppm.

3. The process according to claim 1, characterized in that steps a) to e) are carried out continuously.

4. The process according to claim 1, characterized in that the fiber material is present in the form of a textile fabric.

5. The process according to claim 1, characterized in that the fiber material consists of cellulose fibers to an extent in the range from 50% to 100% by weight.

6. The process according to claim 1, characterized in that the product
P^{⊕}(CH₂OH)₄Cl^{⊖}
is used as tetrakishydroxymethylphosphonium compound.

7. The process according to claim 1, characterized in that step a) uses a product formed by reaction of 2 mol of the tetrakishydroxymethylphosphonium compound with 0.7 to 1.5 mol of urea, this reaction being carried out in the temperature range from 20° C. to 120° C.

8. The process according to claim 7, characterized in that the aqueous mixture used in step a) comprises 10% to 50% by weight of the reaction product.

9. The process according to claim 1, characterized in that step c) uses an aqueous solution of ammonia or gaseous ammonia and an aqueous solution of ammonia.

10. The process according to claim 1, characterized in that step d) uses an aqueous solution of hydrogen peroxide.

11. The process according to claim 1, characterized in that said solution A used comprises phosphoric acid.

12. The process according to claim 1, characterized in that said solution A comprises a product that binds formaldehyde.

13. The process according to claim 1 characterized in that the aqueous solution in step e) has a pH from 7.5 to 12.0 at 20° C.

14. The process according to claim 1 characterized in that the treating of the fiber material with said solution A is carried out after step e).

15. The process according to claim 1, characterized in that the fiber material is treated with such an amount of solution A that the fiber material at the end of the process has a formaldehyde content of not more than 100 ppm.

16. The process according to claim 1 characterized in that said solution A comprises a product that binds urea.
